(19) United States
(12) Patent Application Publication
(10) Pub. No.: US 2004/0053164 A1
(43) Pub. Date: Mar. 18, 2004

(54) Image recording material comprising electronic element

(75) Inventor: Toyoki Nishijima, Tokyo (JP)

Correspondence Address: Muserlian, Lucas and Mercanti, 600 Third Avenue, New York, NY, 10016, US

(73) Assignee: Konica Corporation, Tokyo (JP)

(21) Appl. No.: 10/657,493

(22) Filed: Sep. 8, 2003

(30) Foreign Application Priority Data
Sep. 12, 2002 (JP) JP2002-266636

(51) Int. Cl. G03C 1/76; G03C 1/005

(52) U.S. Cl. 430/270.1; 430/564

(57) ABSTRACT

An image recording material comprising: a substrate; an electronic element layer comprising an electronic element capable of radio communicating on the substrate; a white pigment-containing layer containing a white pigment on the electronic element layer; and an image forming layer on the white pigment-containing layer, herein, in the white pigment layer, a variation coefficient S/R of a ratio of a white pigment-occupying area per unit area is 0.25 or less, S is a standard deviation of the ratio and R is an average value of the ratio.

### TECHNICAL FIELD

The present invention relates to an image recording material, especially to an image recording material comprising an electronic element capable of radio communicating.

### TECHNICAL BACKGROUND

Instead of conventional magnetic cards having magnetic stripes, IC cards having a larger memory capacity are utilized as an ID card for identification. The aforesaid IC card comprises IC chips (IC modules) in the card interior and is structured to make it possible to result in radio communication such as data transmitting and receiving with external instruments via electric contact points provided on the surface or a loop antenna in the card interior.

Radio communication between the IC card and external instruments is achieved employing either a so-called contact type using electric contact points or a so-called non-contact type using an loop antenna installed in the card interior to send and receive signals.

Incidentally, there are IC cards having an image forming surface which is comprised of photographic paper and on which sublimated ink images are formed, and also cards which are capable of utilizing image information as well as electronic information by forming the photographic portrait of the card bearer on an image forming surface and recording personal information of the card bearer on an IC chip.

Namely, in Japanese Unexamined Patent Application Publication (hereinafter, referred to as merely JP-A) No. H7-333783, a photographic paper card, which is prepared by adhering on one surface or both surfaces of an IC card a very thin unexposed reflection type film, a very thin reflection type paper, or a peelable paper, is disclosed.

Further, in JP-A No. H9-323490, a formation of a multi-level image such as a portrait on an IC card with employing a sublimation transfer system is disclosed. The multi-level image is formed by employing, as an image forming surface, the IC card surface on the side which is not provided with IC chips of an IC chip installing substrate or an image forming position which is adjusted so that IC chips, a loop antenna, and wiring are not present in the interior of the IC card at the image forming position.

Still further, in JP-A No. H11-11064, problems have occurred in which, during production of IC chip containing image forming materials employing injection molding, the aforesaid IC chip moves from the specified position due to action of resins injected into the die. However, techniques are known in which displacement of the IC chip from the specified position due to inflow of resins is minimized by arranging an air-suction means at the die portion which is formed employing porous materials.

However, no aforesaid patent publications have sufficiently studied the image quality formed in the image forming portion on IC cards. In the IC card described in JP-A No. 7-333783, which is prepared by adhering photographic paper, problems have been found in which image non-uniformity tends to occur. Further, since the IC card disclosed in the aforesaid Patent Publication is structured by adhesion of photographic paper, problems have occurred in which when the card is repeatedly used or placed in the pocket of the bearer, the photographic paper peels from the surface of the IC card due to degrading of the adhesion surface caused by repeated use as well as effects of perspiration.

As a result, awaited has been appearance of a stabilized image recording material which makes it possible to form images exhibiting excellent image quality and results in no peeling of the image layer from any portion of the IC card over an extended period of time.

### SUMMARY OF THE INVENTION

From the viewpoint of the aforesaid problems, the present invention was achieved. An aspect of the present invention is to provide an image recording material including an electronic element in its interior, which results in uniform images when images such as a portrait are formed on an IC card, and results in no peeling of the image layer due to repeated use of the aforesaid card or human perspiration when the aforesaid card is always placed in a pocket.

Further, JP-A No. 11-11064 makes it possible to minimize displacement of the IC chip during ejection molding. However, problems have occurred in which since the location of the IC chip is not visible from the card surface, the aforesaid IC chip is erroneously damaged while cutting the molded card to the specified size. Further, problems have occurred in which since the location of the IC chip in the card is not identified, it takes a time to read out information recorded in the chip.

Another aspect of the present invention is to provide an image recording material enabling high productivity and reliability in such a manner that even though IC chips are not visible from the surface, the aforesaid IC chips are not erroneously damaged during cutting the IC card to the specified size, and recording and reading information is rapidly carried out.

In the present invention, it was discovered that when a white pigment-containing layer was arranged on a substrate under specified conditions, it was possible to prepare an image recording material containing an electronic element, which resulted in excellent image quality with image uniformity and resulted in no peeling of the image layer even when the card was repeatedly used and was continuously placed in a pocket. Namely, the present invention is achieved employing any one of the structures described below.

(1) A image recording material comprising:

a substrate;

an electronic element layer comprising an electronic element capable of radio communicating on the substrate;

a white pigment-containing layer containing a white pigment on the electronic element layer; and

an image forming layer on the white pigment-containing layer,

wherein, in the white pigment-containing layer, a variation coefficient S/R of a ratio of a white pigment-occupying area per unit area is 0.25 or less, S is a standard deviation of the ratio and R is an average value of the ratio.

The layer on the white pigment-containing layer, as described herein, refers to the layer provided farther from the substrate than the white pigment-containing layer, and another layer may be provided between them.

The image forming layer, as described herein, refers to a layer on which images such as a portrait or text are formed employing an image forming apparatus such as a silver halide photographic material processing apparatus.

The electronic element layer, as described herein, refers to, for example, a layer, which contains an electronic element capable of radio communicating such as an IC chip in an IC card.

The electronic element, as described herein, refers to an element such as an IC chip, which stores communicating information during radio communication between the IC card and external equipment. However, in the present invention, included are, other than the IC chip, accessories such as a loop antenna, which is a communication means between the IC card and external equipment, and tuning capacitors enabling smooth information exchange.

The ratio of white pigment-occupying area, as described herein, refers to the ratio of the occupied area per unit area of white pigment particles in the white pigment-containing layer.

(2) An image recording material comprising:

a substrate comprising an electronic element capable of radio communicating;

a white pigment-containing layer containing a white pigment on the substrate; and

an image forming layer on the white pigment-containing layer,

wherein, in the white pigment-containing layer, a variation coefficient S/R of a ratio of a white pigment-occupying area per unit area is 0.25 or less, S is a standard deviation of the ratio and R is an average value of the ratio.

The image recording material of the present invention may has a structure in which the electronic element capable of radio communicating is installed in a substrate made by pulp base paper as described below, instead of in an independent layer as described in FIG. 1.

(3) Further, in the above-described structures (1) and (2), it is preferable that the white pigment in the white pigment-containing layer comprises a rutile type titanium dioxide.

As noted above, in the present invention, it was discovered that by arranging the white pigment containing-layer under the aforesaid specified conditions in the image recording material, images such as portraits formed on the image forming layer exhibited uniformity and the image layer of the image recording material having an electronic element was not peeled away during repeated use. In conventional techniques, it has been known that by providing a white pigment-containing layer, quality such as sharpness, glossiness, and whiteness of images formed on the recording materials is enhanced. However, by arranging a white pigment-containing layer under the specified conditions, it was not entirely expected that an image recording material could be prepared which overcame problems with image non-uniformity due to exposure conditions.

Further, in the present invention, discovered was an image recording material containing an electronic element, which resulted in inhibiting an image uniformity by arranging a porous layer comprised of minute pores on the substrate.

Consequently, in the above-described structures (1) and (2), it is preferable that the image recording material has a porous layer between the electronic element containing layer and the image forming layer.

The porous layer, as described herein, refers to a layer in which minute pores are arranged in a uniformly dispersed state. Specifically listed is one in which minute particles such as minute hollow particles or minute porous particles, are incorporated into a biaxially oriented film-shaped resinous sheet.

Further, it has been discovered in the present invention that by providing a printing surface having a printed image on the opposite side of the image forming layer, and further determining the installation position of the electronic element corresponding to the printing image, it was possible to identify the IC chip installation position, even though the IC chip was not visible from the card surface, whereby the IC chip was less likely to be erroneously damaged while cutting the card to the specified size, and it was possible to easily achieve recorded information reading. Thus, the following structure is also preferable in the present invention.

(3) An image recording material comprising:

a substrate; and

an electronic element layer comprising an electronic element capable of radio communicating,

wherein the image recording material further comprises an image forming layer on one side of the substrate and comprises a printed surface having a printed image on the other side of the substrate, and the electronic element is positioned at a predetermined position associated with a position of the printed image.

As another structure preferable in the present invention, there is a structure described below.

(4) An image recording material comprising:

a substrate; and

an electronic element layer comprising an electronic element capable of radio communicating,

wherein the image recording material further comprises an image forming layer on one side of the substrate and comprises a printed surface having a printed image on the other side of the substrate, and the printed image is formed by ink obtained by blending the electronic element with a colorant.

In the embodiment described in (4) above, the opposite surface is printed employing a printing ink prepared by blending electronic element with a printing ink. As a result, the electronic element is localized in the specified positions which are adhered with the printing ink, whereby it is possible to achieve quick information recording and reading. Further, the color of the electronic element tends to be different from the substrate. By blending the electronic elements with the printing ink and arranging the resulting blend on the card, enhancement in image quality was discovered due to a decrease in non-uniformity on the rear side surface of the card.

In the above-described structures (1) to (4), it is preferable that the image forming layer comprises a silver halide photographic emulsion.

As a result of the structure described above, an image recording material, which exhibits ample gradation suitable for forming portraits can be obtained. Further, silver halide photographic images are formed in the image forming layer integrally arranged in the image recording material, whereby it is possible to prepare a highly durable image recording material in which the resulting image is not peeled from the card during repeated use or under an ambience of high temperature and/or high humidity.

### BRIEF DESCRIPTION OF THE DRAWINGS

FIG. 1 is a schematic view showing an example of the representative layer configuration of the image recording material according to the present invention.

FIG. 2 is a schematic view showing an arrangement example of an electronic element in the image recording material according to the present invention.

FIG. 3 is a schematic view showing an example of the image recording material provided with a printing image on the printable surface.

### PREFERRED EMBODIMENTS OF THE INVENTION

The present invention relates to image recording material capable of radio communicating, which comprises a substrate having thereon a plurality of layers such as a white pigment-containing layer, and the like.

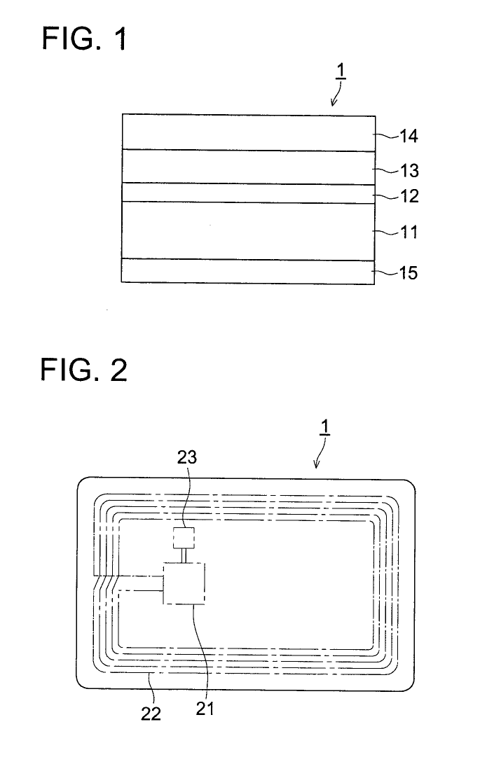

FIG. 1 is a schematic view showing a cross-section of an image recording material comprised of the representative layers of the present invention.

Image recording material 1, according to the present invention, comprises substrate 11 (hereinafter occasionally referred to as a support), which is a support for each of the layers described below, having thereon electronic element layer 12 containing an electronic element capable of radio communicating, such as an IC chip, a white pigment-containing layer comprised of specific white pigments, porous layer 13 containing minute pores, and image forming layer 14, on which images such as a portrait and the like are formed. Further, aforesaid image recording material 11 comprises printing layer 15 on the opposite side the side having the aforesaid layers of the substrate.

Image recording material 1 according to the present invention is characterized in that electronic element layer 12 is provided between substrate 11 and white pigment-containing layer 13, while image forming layer 14 is provided on white pigment-containing layer 13.

Further, in the image recording material according to the present invention, electronic element(s) may be arranged together with a printing ink on the aforesaid printable layer without provision of electronic element layer 12.

Printable layer 15 is prepared, for example, by applying a resinous coating to the substrate surface. By so doing, it is possible to print textual data employing a fusion type ink, and to directly write employing writing means such as ball-point pens, felt pens, or common lead pencils.

The white pigment-containing layer will now be described.

The image recording material according to the present invention is characterized in comprising a white pigment-containing layer on the image forming layer side. It is preferable that white pigment having an average particle diameter in the range of 0.1-0.25 μm are incorporated, and it enables forming excellent multi-level images such as a portrait with maximum image uniformity which is the desired effect of the present invention.

The average particle diameter, as described herein, refers to the average primary particle diameter and the average diameter of white pigment particles themselves. The average primary particle diameter of the white pigment according to the present invention is determined as follows. A group of white pigment particles is observed employing an electron microscope and the cubic root of the particle volume in which the product of a particle volume by its frequency reaches the maximum value is designated as the average particle diameter.

In the present invention, the average particle diameter of white pigments is preferably in the range of 0.1-0.25 μm, is more preferably in the range of 0.13-0.23 μm, and is most preferably in the range of 0.15-0.20 μm.

In the present invention, as long as the average particle diameter is within the aforesaid range, white pigments may be employed individually or in combinations of a plurality of different ones. When a plurality of white pigments having different average diameters is employed in combination, the average primary particle diameter of the resulting mixed white pigment is preferably in the range of 0.1-0.25 μm.

Further, in the image recording material according to the present invention, when the variation coefficient of a ratio of the white pigment-occupying area, which shows degree of dispersion of white pigments, was at most 0.25, it was found that the effects of the present were exhibited in such manner that beautifully high quality and rich gradation images with maximal image uniformity are produced.

Degree of dispersion of coated white pigments is evaluated as follows. The white pigment-containing layer of a photosensitive material is melted employing proteolytic enzymes and the like, and the resulting white pigments are imaged employing an electron microscope. Subsequently, the imaged occupying area is determined and the aforesaid degree of dispersion is evaluated based on the variation coefficient of the ratio of the white pigment-occupying area (in percent).

Methods to adjust the variation coefficient of the ratio of the white pigment-occupying area to 0.25 or less include a method in which white pigments are sufficiently kneaded in the presence of surfactants. Further, it is possible to adjust the aforesaid variation coefficient employing a method in which a large particle component and a small particle component are removed utilizing centrifugal separation.

The most representative method to determine the ratio of the white pigment-occupying area (in percent) is as follows. The area under observation is divided into 6 μm×6 μm unit areas adjacent to each other, and the white pigment occupying area (Ri) (in percent) of particles projected on the unit area is measured.

The variation coefficient of the ratio of the white pigment-occupying area (in percent) is calculated as a ratio of S/R, wherein R is the average value of Ri, and S is the standard deviation of Ri. The number of particles to be measured in the unit area is preferably at least 50. Accordingly, variation coefficient S/R is obtained employing the formula described below:

S/R=[Σ(Ri−R)n−1]^{1/2}/(ΣRi/n)

wherein Σ X represents the total sum of i=1 to n.

As noted above, when the variation coefficient of the ratio of the white pigment-occupying area is controlled to 0.25 or less, the effects of the present invention are exhibited in that high quality images of excellent image uniformity are formed on the image forming layer. In order to achieve more pronounced effects, the aforesaid variation coefficient is preferably at most 0.20, is more preferably at most 0.15, and is most preferably at most 0.10.

Further, in the image recording material according to the present invention, when rutile type titanium oxide is incorporated into the white pigment-containing layer as a white pigment, beautifully high quality images of excellent image uniformity are formed on the image forming layer. Incidentally, in the present invention, it was confirmed that the more content ratio of rutile type titanium oxide, the more optimal was image uniformity.

Further, in the present invention, it is not always essential to use only rutile type titanium oxide alone, and along with rutile type titanium oxide, it is acceptable to use other inorganic and/or organic white pigments. Listed as specific examples are alkaline earth metal sulfates such as barium sulfate, alkaline earth metal carbonates such as calcium carbonate, fine silicic acid powder, silicas of synthetic silicates, calcium silicate, alumina, alumina hydrates, titanium oxide, zinc oxide, talc, and clay. Of these, most preferably listed are barium sulfate, calcium carbonate, and other titanium oxides such as a anatase type.

The aforesaid white pigments are dispersed and incorporated into a resinous layer comprised of, for example polyethylene and the like, or a hydrophilic colloidal layer comprised of gelatin and the like, to form a white pigment containing layer. Of these, it is preferable that white pigments are dispersed in and incorporated into a polyethylene layer to form a white pigment-containing layer.

As mentioned above, white pigment containing layer 13 according to the image recording material of the present invention is arranged between substrate 11 and image forming layer 14. Between the aforesaid substrate and the aforesaid image forming layer, it is possible to arrange, other than the white pigment-containing layer, the electronic element layer 12 containing an radio communicatable electronic element in the optional position on the aforesaid substrate, and layers such as a sublayer or an interlayer which function to promote formation of high quality images.

The porous layer in the image recording material according to the present invention will now be described.

The porous layer according to the present invention is a layer in which minute pores are provided in a uniform dispersion state. The aforesaid layer is prepared by applying a layer containing minute particles such as minute hollow particles or minute porous particles onto film which is prepared employing a resin molding means to form film shaped sheets such as biaxially oriented sheets. Specific examples of minute hollow particles include JSR Hollow Particle SX863(P), manufactured by JSR Co., Ltd., as crosslinked styrene-acryl hollow resinous particles. A porous layer comprised of hollow resinous particles is prepared as follows. The aforesaid hollow resinous particles and a porous particle paste composition are added to a gelatin solution and the resulting mixture is stirred employing a homomixer. Thereafter, surfactants are added to prepare a coating composition which is applied to a film shaped sheet.

Further, specific examples of minute porous particles include minute inorganic porous particles disclosed in JP-A No. 60-198286, such as silica, clay, diatomaceous earth, calcium carbonate, calcium sulfate, satin white, aluminum silicate, alumina, and zeolite.

Incidentally, in the image recording material of the present invention, the aforesaid porous layer may be combined with another layer while arranging it on or under the aforesaid white pigment-containing layer.

The electronic element layer, which constitutes the image recording material according to the invention, will now be described. Incidentally, the embodiments of the electronic element layer, as described in the present invention are not limited as long as the aforesaid electronic element is incorporated. Other than the embodiment in which an electronic element is incorporated by providing the aforesaid electronic element layer in the image recording material, embodiments are included in which, for example, the aforesaid electronic element is included in a paper base during paper making or the aforesaid electronic element is interposed between two substrates.

The electronic element capable of radio communicating, as described herein, which is employed in the image recording material according to the present invention, refers to an IC chip which specifically sends and receives information utilizing radio communication and records the aforesaid information. Further, other than the aforesaid chip, included are a loop antenna and a tuning capacitor, which are communication means to send and receive information, and the associated wiring to connect these parts. The maximum length of the IC chip used in the invention is preferably 2 mm or less, more preferably 1 mm or less, still more preferably 0.6 mm or less, and most preferably 0.4 mm or less. The maximum length of the IC chip of the present invention means a length, which is longest in the projected area of the IC chip. For example, when the IC ship is a square, the maximum length is the length of the diagonal line of the square.

FIG. 2 is a schematic view showing an arrangement example of electronic elements in the image recording material of the present invention. Image recording material 1 comprises aforesaid substrate 11 having thereon IC chip 21, loop antenna 22, and tuning capacitor 23 which are connected via wiring and arranged appropriately. Further, image recording material 1 according to the present invention forms high quality images of excellent image uniformity on aforesaid image forming layer 14.

The image forming layer according to the present invention will be described. The example of the aforesaid image forming layer includes one which forms images such as portraits and text, for example, through exposure and photographic processing employing a silver halide light-sensitive photographic material processor. By employing a silver halide emulsion layer as the aforesaid image forming layer, gradation enhanced images suitable for portraits are prepared, and simultaneously, durable images against the effects of temperature and humidity are also prepared.

Further, other than image formation employing a silver halide light-sensitive photographic material processor, the image forming layer in the image recording material of the present invention may be used to form images, employing image forming devices such as ink jet printers, sublimation ink type printers, or fusion ink type printers.

The substrate constituting the image recording material according to the present invention will now be described.

Substrates employed in the image recording material according to the present invention include base paper other than plastic sheet shaped resinous materials.

It is possible to incorporate electronic elements into a substrate, which is comprised of pulp materials. Namely, incorporating electronic elements into a substrate, as described herein, is achieved as follows. Since the base paper is made employing short fibers of a length from several mm to several cm, it is possible to incorporate electronic elements into the substrate by including the aforesaid electronic element among the short fibers. By incorporating electronic elements into the substrate itself, it is possible to decrease the thickness of the card. As a result, it is possible to prepare an electronic element containing image recording material, which results in excellent portability.

Further, when a substrate is produced employing base paper comprised of pulp materials, it is ease to dispose of cards which have expired and the like. Still further, it is possible to easily recover electronic elements from expired cards and to reuse them. As a result, it is possible to provide environmentally friendly IC cards in which image recording materials utilize base paper as a substrate, as opposed to conventional plastic cards.

When base paper is employed as a substrate, which is used to prepare the image recording material according to the present invention, it is preferable that both sides of the base paper are laminated with polyolefin resins.

Base paper employed as the aforesaid substrate may be made employing raw materials selected from those which are customarily employed to prepare photographic paper as well as ink jet sheets. Examples include natural pulp, synthetic pulp, mixtures of natural pulp and synthetic pulp, and in addition, raw materials for various combination paper. Generally, widely employed is natural pulp which is comprised of softwood pulp, hardwood pulp, and a mixture of both as the main component. Further, blended may be additives such as sizing agents, fixing agents, strength enhancing agents, fillers, antistatic agents, and dyes or pigments which are generally employed in paper making. Further, the surface of base paper may be appropriately coated with surface sizing agents, surface strengthening agents, and antistatic agents.

Further, in the image recording material according to the present invention, it is possible to incorporate IC chips into the substrate in such a manner that during production of the substrate from pulp, IC chips are entwined among plant fibers.

Generally, the substrate, comprised of base paper, which is employed to prepare the image recording material according to the present invention, has a weight of 50-300 g/m² and exhibits desired surface smoothness. Selected as resins which are used to laminate both sides of the aforesaid substrate are ethylenes, polyethylene phthalates, and α-olefins, for example, homopolymers such as polypropylene, copolymers of at least two of the aforesaid olefins, or mixtures of at least two of various these polymers. Specifically preferred polyolefin resins include low-density polyethylene, high-density polyethylene, and mixtures thereof.

The molecular weight of polyolefin resins which are laminated onto the aforesaid substrate is not particularly limited, but resins of a molecular weight in the range of 20,000-200,000 are preferably employed.

Further, the thickness of the polyolefin coated layer on the side having the image forming layer of the image recording material is preferably 25-50 μm, and is more preferably 25-35 μm.

Polyolefin laminated onto the rear surface of the substrate is commonly a mixture consisting of low-density polyethylene and high-density polyethylene, and the aforesaid mixture itself is fused and laminated. Further, the resulting layer is commonly subjected to a matting treatment.

During lamination of both sides of the substrate, in order to minimize curling of image recording materials after image formation under commonly encountered ambience, various means are employed so that the density of the resinous layer on the surface side is controlled to be somewhat greater than the rear side, or the laminated amount of the rear side is controlled to be greater than the surface side.

Further, it is possible to laminate both sides of the substrate with a polyolefin resinous composition employing a melt extrusion coating method. Further, it is preferable that the surface of a substrate and if desired, both surfaces are subjected to a corona discharge treatment or a flame treatment. Still further, in order to enhance printing properties, writability, and antistatic properties, it is preferable that a back coating layer is provided on a laminated layer on the front side, a sublayer to enhance adhesion properties to photographic emulsion or a laminated layer on the rear side.

Further, in the image recording material according to the present invention, the aforesaid substrate may be formed employing plastic sheet-shaped resinous materials. Polymeric materials are used which are customarily employed as a card material. Specific examples include polymeric materials such as polyvinyl chloride resins, polyester resins, polyvinyl alcohol resins, polyvinyl butyral resins, epoxy resins, or acryl resins.

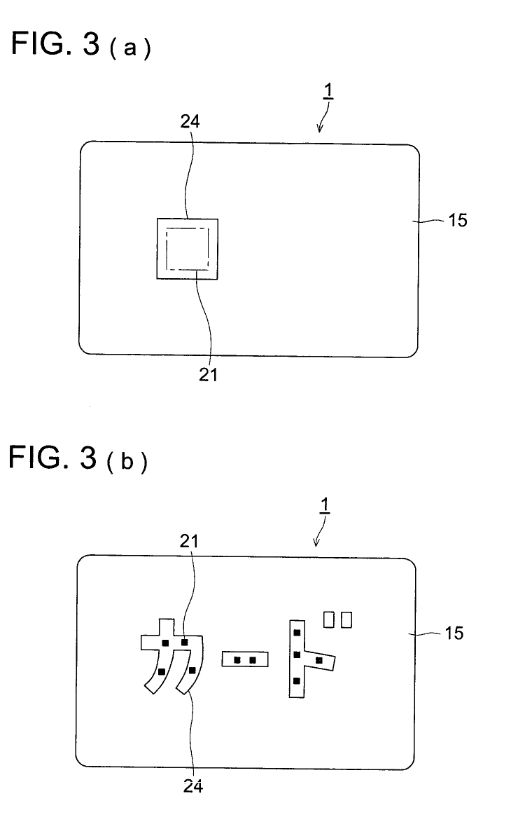

An image recording material will now be described which allows identification of the location of the electronic element of the present invention. FIG. 3 is a schematic view showing an example of an image recording material provided with printing image 24 on printable layer 15. In the image recording material of the present invention, even though an IC chip is not visible from the card surface, it is possible to identify the location of the IC chip in the following manner. As shown in FIG. 3(a), a printed surface is provided on the side opposite the image forming layer side. The position to locate the electronic element is decided corresponding to the printing position on the aforesaid printing surface. Alternatively, the printing position is decided to correspond to the IC chip locating position.

Namely, the image forming layer is provided on one side surface of the image recording material and the printed surface is provided on the surface opposite the surface having the aforesaid image forming layer. Subsequently, printing is carried out onto the printing surface so that the electronic element is positioned just under the printed image on the aforesaid printing surface. As noted above, by deciding the position to locate the electronic element corresponding to the printing position, it is possible to identify the IC chip location, even though the aforesaid IC chip is not visible from the card surface. As a result, when molded cards are cut to the specified size, the IC chip is not erroneously damaged. Further, since it is possible to identify the IC location, it is possible to quickly store information into the IC chip and also possible to quickly read information recorded on the IC chip.

Further, when a printing image is formed employing an ink prepared by blending colorants with minute electronic elements, as shown in FIG. 3(b), electronic elements 21 are localized only in the printed image. As noted above, by arranging minute electronic elements 21 in the printing image, it is possible to more quickly record and read information. Still further, since the color of the electronic element tends to be different from that of the substrate, effects are found in that by blending the electronic element with the printing ink and printing the resulting mixture on the card, uniformity of the printable layer is maximized, whereby enhancement in image quality is achieved.

### EXAMPLES

The present invention will now be detailed with reference to examples. However, the embodiments of the present invention are not limited thereto.

(First Experiment)

A substrate was prepared by laminating high-density polyethylene onto both surfaces of basis weight 180 g/m² paper pulp, and a layer in which IC chips were to be installed was provided on the aforesaid support. Subsequently, on the aforesaid layer in which the IC chips were installed, were formed a white pigment containing-layer employing titanium oxide and an image forming layer. In such a manner, Examples 1-5, as well as Comparative Examples 1-6, were prepared which incorporated IC chip(s) installed in image recording materials in a credit card size, having a layer configuration shown in FIG. 1.

Incidentally, in Example 5, when the substrate was made, the IC chip is incorporated in the substrate by combining the fiber of the pulp with the electronic element, instead of preparing the electronic element layer containing the electronic element therein.

Further, the following data shown below were recorded in the IC chip employed in each sample as reading data:

Name: Momotaro Nippon

Birth Date: Oct. 10, 1964

Employee No.: 1234567890

Address: 3 Go, 9 Ban, 8 Chome, Konakadai-machi, Inage-ku, Chiba-shi, Chiba-ken

Telephone No.: 047 (256) 1234

Each of Examples 1-5 and Comparative Examples 1-6 was subjected to specified exposure and processing to form images. The image uniformity of the resulting images was evaluated.

<Evaluation of Image Uniformity>

Exposure was carried out to result in a gray density of 1.0 after image formation. The image uniformity of images after photographic processing was visually observed and evaluated based on the criteria below. Rankings A, B, and C were judged to be commercially viable.

TABLE 1

| | | Condition of White | | | |
|---|---|---|---|---|---|
| | | Pigment Containing Layer | | | |
| | | Rutile | Average | | |
| | | Type | Particle | | Image |
| | IC Chip Installed | Presence/ | Diameter | | Uni- |
| | Position | Absence | (μm) | S/R | formity |
| Example 1 | Between White | Absence | 0.08 | 0.11 | C |
| | Pigment Contain- | | | | |
| | ing Layer and | | | | |
| | Support | | | | |
| Example 2 | Between White | Absence | 0.15 | 0.14 | B |
| | Pigment Contain- | | | | |
| | ing Layer and | | | | |
| | Support | | | | |
| Example 3 | Between White | Presence | 0.15 | 0.14 | A |
| | Pigment Contain- | | | | |
| | ing Layer and | | | | |
| | Support | | | | |
| Example 4 | Between White | Presence | 0.15 | 0.24 | B |
| | Pigment Contain- | | | | |
| | ing Layer and | | | | |
| | Support | | | | |
| Example 5 | In Support | Absence | 0.15 | 0.14 | C |
| Compar- | Between White | Absence | 0.08 | 0.30 | D |
| ative | Pigment Contain- | | | | |
| Example 1 | ing Layer and | | | | |
| | Image Forming | | | | |
| | Layer | | | | |
| Compar- | Between White | Presence | 0.08 | 0.30 | D |
| ative | Pigment Contain- | | | | |
| Example 2 | ing Layer and | | | | |
| | Image Forming | | | | |
| | Layer | | | | |
| Compar- | Between White | Absence | 0.15 | 0.31 | D |
| ative | Pigment Contain- | | | | |
| Example 3 | ing Layer and | | | | |
| | Image Forming | | | | |
| | Layer | | | | |
| Compar- | Between White | Absence | 0.08 | 0.11 | D |
| ative | Pigment Contain- | | | | |
| Example 4 | ing Layer and | | | | |
| | Image Forming | | | | |
| | Layer | | | | |
| Compar- | Between White | Absence | 0.08 | 0.30 | D |
| ative | Pigment Contain- | | | | |
| Example 5 | ing Layer and | | | | |
| | Support | | | | |
| Compar- | Between White | Absence | 0.35 | 0.31 | E |
| ative | Pigment Contain- | | | | |
| Example 6 | ing Layer and | | | | |
| | Support | | | | |

A: image uniformity excellent
B: image uniformity slightly degreaded
C: image uniformity was somewhat degraded, but still commercially ciable
D: image uniformity was undesirable, and commercially unviable
E: image uniformity was markedly unacceptable
Table 1 shows the results.

As shown in Table 1, it was confirmed that in the image recording materials according to the present invention, high quality images of desired image uniformity were prepared. Further, when information recorded in the built-in IC chip was read with regard to each of the aforesaid samples, in the image recording materials according to the present invention, it was possible to instantly read the information recorded on the IC chip. On the other hand, it was found that in some of the comparative examples, reading was delayed by several seconds.

(Second Experiment)

1. Preparation of Example 6

In this experiment, an image recording sheet (having a width of 200 mm and a length of 300 mm, on which IC chips were arranged at intervals of 64 mm across the width at 99 mm along the length) was employed which was Example 1 prepared in First Experiment and was capable of producing 9 cards in a credit card size (a width of 58 mm and a length of 85 mm) and which were in the pre-cutting stage. The word “TEST” was printed, employing a printing ink, on the printable layer provided on the support side opposite the image forming layer side of the aforesaid image recording sheet.

In such a case, printing was performed so that the central position (between letters E and S of “TEST”) of the printed word matched to the arranged position of the built-in IC chip. Thereafter, the aforesaid sheet was cut to prepare 9 credit cared size samples, utilizing the central position of the printed word on the aforesaid sheet as a guide. This operation was performed 10 times, whereby a total of 90 samples were prepared.

2. Preparation of Referential Example 1

In Example 6, instead of installing the IC chip in the image recording material sheet, minute IC chips were incorporated into a printing ink. Subsequently, by employing the printing ink comprising the aforesaid minute IC chips, the word “TEST” was printed on the printable layer provided on the substrate side opposite the image forming layer side in the same manner as Example 6. Thereafter, the aforesaid sheet was cut utilizing the central position of the printed letters on the aforesaid sheet as a guide and 9 credit cards were prepared from each of the 10 sheets. Thus, 90 card samples were prepared.

3. Preparation of Comparative Example 7

The word “TEST” was not printed on the printable layer of the same image forming sheet as in Example 6, but the aforesaid sheet was cut to prepare 9 credit card size samples for a total of 90 samples employing 10 sheets.

4. Evaluation

With regard to the 90 cards which were prepared in aforesaid Example 5 or aforesaid Referential Sample 1, or Comparative Example 7, the number of cards in which the IC chip was damaged during cutting was noted.

As a result, it was confirmed that in Example 6 in which the central position of the printed word was matched to the IC chip arranged position, as well as in Referential Sample 1 in which the IC chip was positioned in the printed word, no IC chips were damaged during the cutting operation. On the other hand, in Comparative Example 7 in which the word was not printed and the IC chip arranged position was not identifiable, the IC chip was damaged in 18 cards.

### EFFECTS OF THE INVENTION

In an image recording material comprising an electronic element capable of radio communicating according to the present invention, by providing, on the substrate, a white pigment containing layer or a porous layer prepared under specific conditions, as well as by installing a electronic element between the aforesaid substrate and the aforesaid white pigment containing layer or the aforesaid porous layer, it was possible to provide an image recording material which maximized image uniformity, further resulted in no peeling of the image layer due to repeated use of the card or humidity effects due to human perspiration while always placed in a pocket, exhibited high image quality and produced consistent images.

Further, in an image recording material comprising an electronic element capable of radio communicating according to the present invention, since it was possible to identify the electronic element installed position based on printed information, it was possible to provide an image recording material in which during card cutting, IC chips were not erroneously damaged, and in addition, it was possible to efficiently carry out information recording on or reading from the IC chip.

What is claimed is:

1. An image recording material comprising:
a substrate;
an electronic element layer comprising an electronic element capable of radio communicating on the substrate;
a white pigment-containing layer containing a white pigment on the electronic element layer; and
an image forming layer on the white pigment-containing layer,
wherein, in the white pigment-containing layer, a variation coefficient S/R of a ratio of a white pigment-occupying area per unit area is 0.25 or less, S is a standard deviation of the ratio and R is an average value of the ratio.

2. The image recording material of claim 1, wherein the variation coefficient S/R is 0.15 or less.

3. The image recording material of claim 1, wherein the white pigment has an average particle diameter of 0.1 to 0.25 μm.

4. The image recording material of claim 1, wherein the white pigment comprises a rutile type titanium dioxide.

5. The image recording material of claim 1, wherein the image recording material further comprises a porous layer between the electronic element layer and the image forming layer.

6. The image recording material of claim 1, wherein the image recording material further comprises an printed surface having a printed image on an side of the substrate opposite to the image forming layer side, and the electronic element is positioned at a predetermined position associated with a position of the printed image.

7. The image recording material of claim 6, wherein the electronic element is positioned under the printed image.

8. The image recording material of claim 1, wherein the image forming layer comprises a silver halide photographic emulsion.

9. An image recording material comprising:
a substrate comprising an electronic element capable of radio communicating;
a white pigment-containing layer containing a white pigment on the substrate; and
an image forming layer on the white pigment-containing layer,
wherein, in the white pigment-containing layer, a variation coefficient S/R of a ratio of a white pigment-occupying area per unit area is 0.25 or less, S is a standard deviation of the ratio and R is an average value of the ratio.

10. The image recording material of claim 9, wherein the variation coefficient S/R is 0.15 or less.

11. The image recording material of claim 9, wherein the white pigment has an average particle diameter of 0.1 to 0.25 μm.

12. The image recording material of claim 9, wherein the white pigment comprises a rutile type titanium dioxide.

13. The image recording material of claim 9, wherein the image recording material further comprises a porous layer between the electronic element layer and the image forming layer.

14. The image recording material of claim 9, wherein the image recording material further comprises an printed surface having a printed image on an side of the substrate opposite to the image forming layer side, and the electronic element is positioned at a predetermined position associated with a position of the printed image.

15. The image recording material of claim 14, wherein the electronic element is positioned under the printed image.

16. An image recording material comprising:
a substrate; and
an electronic element layer comprising an electronic element capable of radio communicating,
wherein the image recording material further comprises an image forming layer on one side of the substrate and comprises a printed surface having a printed image on the other side of substrate, and the electronic element is positioned at a predetermined position associated with a position of the printed image.

17. The image recording material of claim 16, wherein the electronic element is positioned under the printed image.
